(19) United States
(12) Patent Application Publication
(10) Pub. No.: US 2026/0107015 A1
(43) Pub. Date: Apr. 16, 2026

(54) METHOD AND APPARATUS FOR VIDEO CODING BASED ON NON-SEPARABLE PRIMARY TRANSFORM

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Dong Gyu Sim, Seoul (KR); Joo Hyung Byeon, Seoul (KR); Min Hun Lee, Uijeongbu-si (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/115,009

(22) PCT Filed: Aug. 17, 2023
(86) PCT No.: PCT/KR2023/012177

§ 371 Date: Mar. 25, 2025

(30) Foreign Application Priority Data
Sep. 29, 2022 (KR) 10-2022-0124290
Aug. 11, 2023 (KR) 10-2023-0105462

(51) Int. Cl. H04N 19/60; H04N 19/11; H04N 19/119; H04N 19/124; H04N 19/129; H04N 19/159; H04N 19/176; H04N 19/18; H04N 19/593; H04N 19/70

(52) U.S. Cl. CPC H04N 19/60; H04N 19/11; H04N 19/119; H04N 19/124; H04N 19/129; H04N 19/159; H04N 19/176; H04N 19/18; H04N 19/593; H04N 19/70

(57) ABSTRACT

A method and an apparatus are disclosed for video coding based on non-separable primary transform. In the disclosed embodiments, a video decoding device acquires inversely-quantized transform coefficients for a transform block of the current block and decodes a Non-separable Primary Transform (NSPT) flag from a bitstream. The video decoding device checks the NSPT flag and, when the NSPT flag is true, determines a non-separable primary inverse transform kernel based on a size of the transform block, an intra prediction mode of the current block, and characteristics of the inversely-quantized transform coefficients. The video decoding device generates residual signals by applying the non-separable primary inverse transform kernel to the transform coefficients.

### TECHNICAL FIELD

The present disclosure relates to a video coding method and an apparatus based on non-separable primary transform.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

The Non-separable Primary Transform (NSPT) technique performs a non-separable primary transform on residual signals of blocks predicted in the intra prediction mode using a pre-trained transform kernel instead of performing vertical and horizontal directional transforms. If the size of a residual block on which transform is performed is W_{tb}×H_{tb}, the size of the non-separable primary transform kernel K is (W_{tb}×H_{tb})×(W_{tb}×H_{tb}). In other words, (W_{tb}×H_{tb}) residual signals are transformed to generate (W_{tb}×H_{tb}) transform coefficients.

For the non-separable primary transform, transform kernels may be defined based on the block shape and the intra prediction mode. For example, utilizing the symmetry characteristics of a square block, 35 transform kernels are defined for square blocks depending on the intra prediction mode. Also, 67 transform kernels are defined for rectangular blocks.

The non-separable primary transform may be applied to the luma component. Also, when the non-separable primary transform is applied, the secondary transform (i.e., Low-frequency Non-separable Transform (LFNST)) may not be performed. Therefore, to improve the video coding efficiency and enhance the video quality, it is necessary to improve the non-separable primary transform and adopt a comprehensive operational method.

### DISCLOSURE

### Technical Problem

The present disclosure seeks to provide a video coding method and an apparatus that perform non-separable primary transform (NSPT) based on the intra prediction mode of a current block, the size of the transform, and characteristics of transform coefficients. Also, the video coding method and the apparatus perform a non-separable primary transform using implicit partitioning on a large transform block for which a non-separable transform may not be applied.

### Technical Solution

At least one aspect of the present disclosure provides a method for reconstructing a current block, performed by a video decoding device. The method includes acquiring inversely-quantized transform coefficients for a transform block of the current block. The method also includes decoding a Non-separable Primary Transform (NSPT) flag from a bitstream. The NSPT flag indicates whether to apply non-separable primary transform. The method also includes checking the NSPT flag. When the NSPT flag is true, the method also includes determining a non-separable primary inverse transform kernel based on a size of the transform block, an intra prediction mode of the current block, and characteristics of the inversely-quantized transform coefficients. The method also includes performing a primary inverse transform by generating residual signals by applying the non-separable primary inverse transform kernel to the transform coefficients.

Another aspect of the present disclosure provides a method for encoding a current block, performed by a video encoding device. The method includes acquiring residual signals for a transform block of the current block. The method also includes determining a non-separable primary transform kernel based on a size of the transform block, an intra prediction mode of the current block, and characteristics of the quantized transform coefficients. The method also includes generating first primary transform coefficients by applying the non-separable primary transform kernel to the residual signals. The method also includes determining explicitly or implicitly a primary transform kernel pair in the vertical and horizontal directions for the transform block. The method also includes generating second primary transform coefficients by applying the first transform kernel pair to the residual signals.

Yet another aspect of the present disclosure provides a computer-readable recording medium storing a bitstream generated by a video encoding method. The video encoding method includes acquiring residual signals for a transform block of a current block. The video encoding method also includes determining a non-separable primary transform kernel based on a size of the transform block, an intra prediction mode of the current block, and characteristics of the quantized transform coefficients. The video encoding method also includes generating first primary transform coefficients by applying the non-separable primary transform kernel to the residual signals. The video encoding method also includes determining explicitly or implicitly a primary transform kernel pair in the vertical and horizontal directions for the transform block. The video encoding method also includes generating second primary transform coefficients by applying the first transform kernel pair to the residual signals.

### Advantageous Effects

As described above, the present disclosure provides a video coding method and an apparatus that perform a non-separable primary transform based on an intra prediction mode of a current block, the size of a transform block, and characteristics of transform coefficients. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram illustrating a portion of a video decoding device in detail according to one embodiment of the present disclosure.

FIG. 7 illustrates a method for determining an inverse transform kernel according to one embodiment of the present disclosure.

FIG. 8 illustrates a method for determining an inverse transform kernel according to another embodiment of the present disclosure.

FIG. 9 illustrates partitioning of a transform block according to one embodiment of the present disclosure.

FIG. 10 illustrates partitioning of a transform block according to another embodiment of the present disclosure.

FIG. 11 illustrates a reconstruction order of subblocks according to one embodiment of the present disclosure.

FIGS. 12A and 12B illustrate an inverse transform process of reconstruction transform coefficients according to one embodiment of the present disclosure.

FIG. 13 illustrates a scanning order for generating a primary transform coefficient vector according to one embodiment of the present disclosure.

FIG. 14 illustrates a scanning order for generating a primary transform coefficient vector according to another embodiment of the present disclosure.

FIG. 15 illustrates a scanning order for generating a primary transform coefficient vector according to one embodiment of the present disclosure.

FIGS. 16A and 16B are flow diagrams illustrating a method for transforming a transform block by a video encoding device according to one embodiment of the present disclosure.

FIG. 17 is a flow diagram illustrating a method for inversely transforming a transform block by a video decoding device according to one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

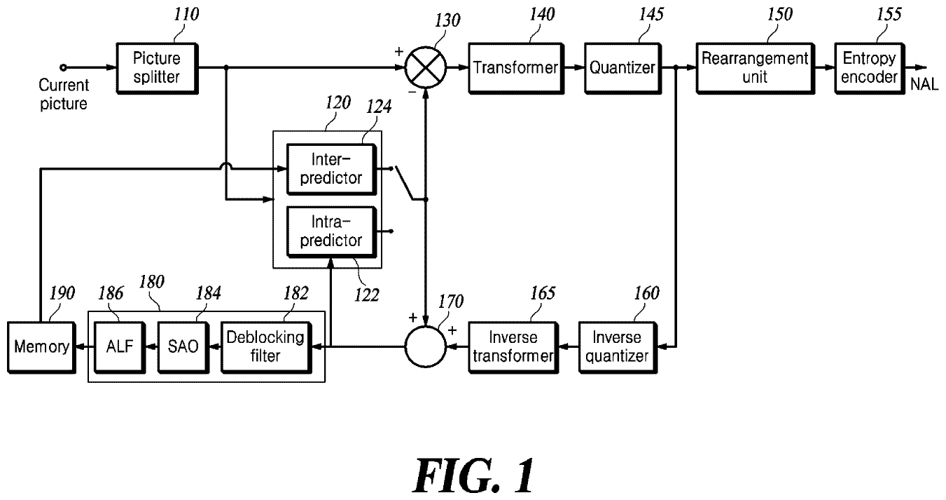

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

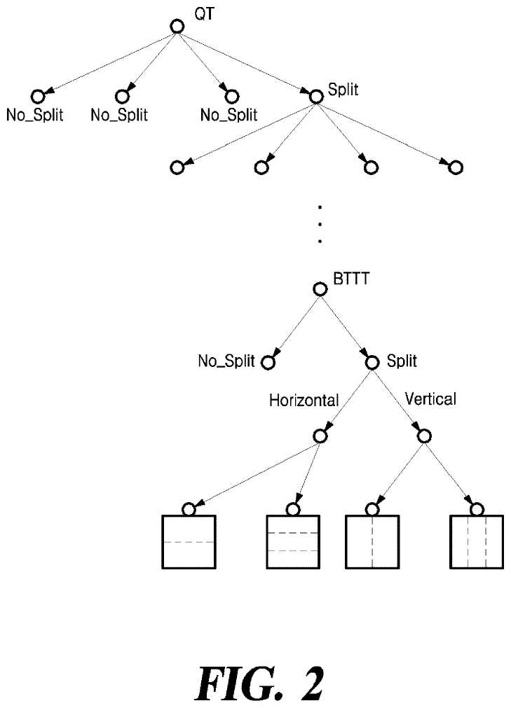

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

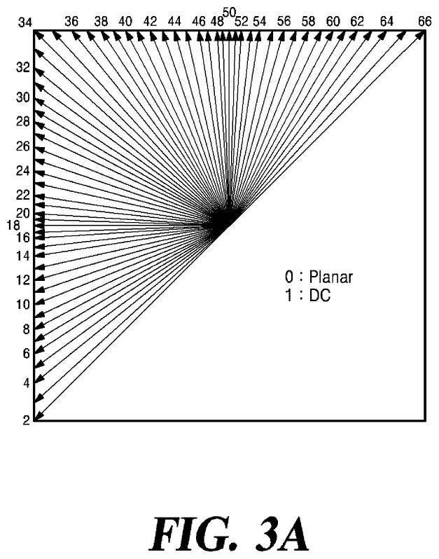

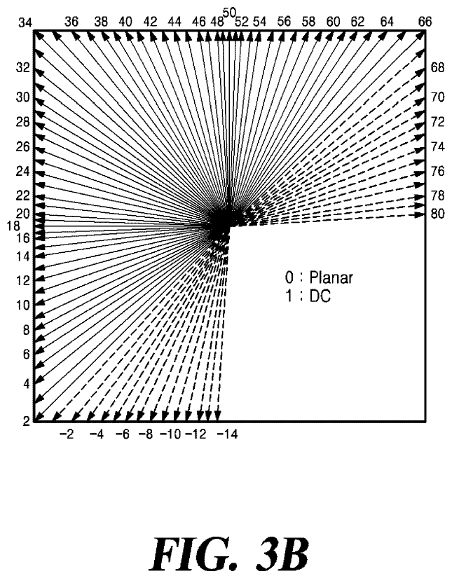

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

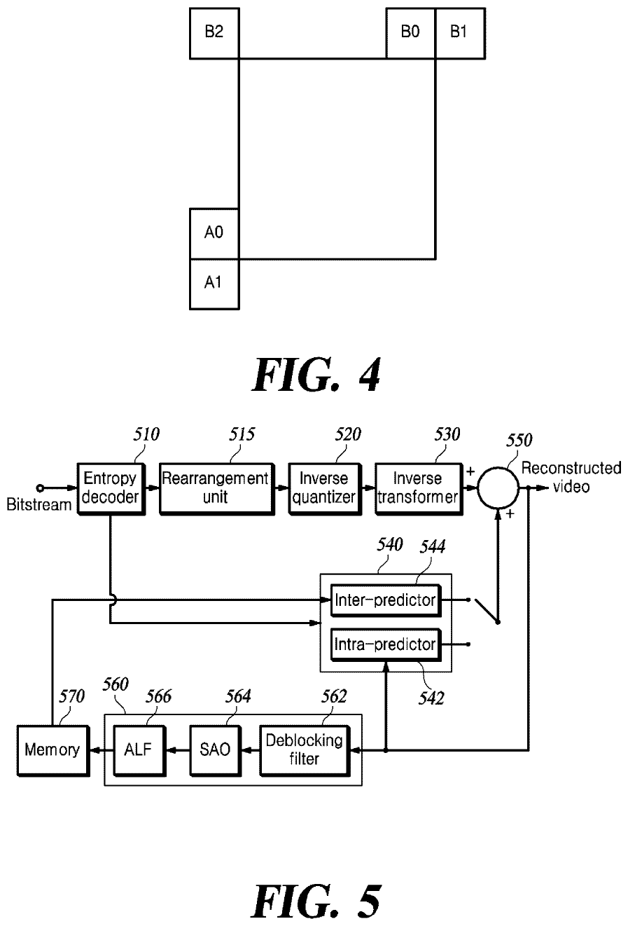

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block. Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that perform a non-separable primary transform (NSPT) based on an intra prediction mode of a current block, the size of a transform block, and characteristics of transform coefficients. Also, the video coding method and the apparatus perform a non-separable primary transform using implicit partitioning on a large transform block for which a non-separable transform may not be applied.

The following embodiments may be performed by the transformer 140 and the inverse transformer 165 in the video encoding device. The following embodiments may also be performed by the inverse transformer 530 in the video decoding device.

The video encoding device in encoding the current block may generate signaling information associated with the present embodiments in terms of optimizing rate distortion.

The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. TRANSFORM TECHNIQUE—PRIMARY TRANSFORM TECHNIQUE

As described above, for efficient video compression, quantization or scaling may be additionally applied to residual signals remaining after prediction based on various prediction techniques. At this time, after applying a transform technique based on the significance of cognitive visual information inherent in the residual signals and gathering the residual signals into a specific region according to their frequency components, scaling may be performed. However, in the case of screen contents, which are not natural signals, the frequency-based transform technique may be inefficient. In this case, the transform technique may be omitted; instead, only scaling may be performed, or encoding/decoding may proceed without applying scaling.

When a transform is applied in HEVC, DCT-II is used as a transform kernel (hereinafter, used interchangeably with transform type) to transform residual signals. However, to apply a more appropriate transform technique depending on the diversity of residual signal characteristics, Multiple Transform Selection (MTS) may be used. MTS determines one or two optimal types among multiple transform types and then transforms a block according to the determined transform type. For example, in VVC, as shown in Table 1, in addition to DCT-II, two other transform types, DCT-VIII and DST-VII, are added so that residual signals may be transformed in various ways.

TABLE 1

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Here, basis functions constitute the transform matrix that defines each transform type. Hereinafter, DCT-II, DCT-VIII, and DST-VII are used interchangeably with DCT2, DCT8, and DST7, respectively.

Meanwhile, a flag that determines whether to use MTS may be controlled at the block level. Also, the use of MTS may be controlled using an activation flag at the higher SPS level.

If MTS is activated in the SPS, a CU-level flag indicating the application of MTS may be displayed. Here, MTS may be applied to the luma component. The CU-level flag may be expressed when both the width and height of the transform block (TB) are less than or equal to 32 pixels, and the Coded Block Flag (CBF), which indicates the presence of non-zero values among transform coefficient levels, is true.

If the CU-level flag is 0, DCT2 may be used as the kernel for both the horizontal and vertical directions. On the other hand, if the CU-level flag is not 0, MTS may be applied. In this case, explicit MTS and implicit MTS may be supported.

In the case of explicit MTS, the kernel used for a TB may be explicitly transmitted. Typically, an index of the transform kernel may be transmitted. For example, as shown in Table 2, the kernel index, referred to as mts_idx, may be defined.

TABLE 2

| mts_idx | 0 | 1 | 2 | 3 | 4 |
|---|---|---|---|---|---|
| trTypeHor | 0 | 1 | 2 | 1 | 2 |
| trTypeVer | 0 | 1 | 1 | 2 | 2 |

Here, trTypeHor and trType Ver represent the transform types in the horizotal and vertical directions, respectively. Also, 0 represents DCT2; 1 DST7; and 2 DCT8.

Meanwhile, in the implicit MTS, for example, in the case of an intra block, the transform type may be determined implicitly even if the MTS is not explicitly signaled. In the VVC, as shown in Equation 1, the transform types in the horizontal and vertical directions may be implicitly determined.

$$trTypeHor = ( nTbW >= 4 \&\& nTbW <= 16 ) ? DST 7 : DCT 2 \qquad [ Equation 1 ]$$

$$trType Ver = ( nTbH >= 4 \&\& nTbH <= 16 ) ? DST 7 : DCT 2$$

Here, nTbW and nTbH represent the lengths of the transform block in the horizontal and vertical directions, respectively.

For instance, when a specific coding technique is applied, either explicit MTS or implicit MTS may be applied. For example, in the case of Matrix-weighted Intra Prediction (MIP), explicit intra MTS may be used. In the case of Intra Sub-Partitions (ISP) mode, implicit intra MTS may be used, and DST7 or DCT2 may be used as the transform type.

When the transform block includes at least one non-DC coefficient, mts_idx is signaled. In other words, if the position of the last significant coefficient according to the scanning order is greater than 0, mts_idx is signaled. On the other hand, if the transform block includes only one non-DC coefficient, signaling of mts_idx is omitted, mts_idx is derived as 0, and DCT2 is applied as the transform kernel.

The first bit of the signaled mts_idx indicates whether mts_idx is greater than 0. If mts_idx is greater than 0 (i.e., pointing to one of the values from 1 to 4), a 2-bit fixed-length code is additionally signaled to specify the signaled mts_idx among the four candidates.

Meanwhile, in the Enhanced Compression Model (ECM) software, which is a next-generation technique, the number and types of MTS kernels are increased, and DST7, DCT8, DCT, DST4, DST1, and identity transform are added.

### II. LOW-FREQUENCY NON-SEPARABLE TRANSFORM (LFNST)

The Low-Frequency Non-Separable Transform (LFNST) technique performs a secondary transform on the low-frequency region among the transform coefficients generated by the primary transform of a transform unit (TU) during intra prediction. From the encoding perspective, the LFNST technique applies a secondary transform to L low-frequency primary transform coefficients out of W×H primary transform coefficients to generate K secondary transform coefficients (where K≤L). Here, the size of the LFNST transform kernel is L×K. In other words, the LFNST technique represents the L low-frequency primary transform coefficients among W×H primary transform coefficients in the form of a 1×L vector, and applies an L×K transform kernel to generate a 1×K vector. Subsequently, the LFNST technique rearranges the 1×K vector into a two-dimensional array in the low-frequency region to use the vector for subsequent processes such as quantization.

Compared to the primary transform that applies separate transform kernels in horizontal and vertical directions, the LFNST technique performs a non-separable transform that transforms a one-dimensional vector.

Meanwhile, the type of transform kernel may be determined based on the intra prediction mode of a current TU, the TU size, and the LFNST index (Ifnst_idx). For example, a set of transform kernels may be determined according to the intra prediction mode (IntraPredMode) of the current TU, as shown in Table 3.

TABLE 3

| IntraPredMode | lfnstTrSetIdx |
|---|---|
| IntraPredMode < 0 | 1 |
| 0 ≤ IntraPredMode ≤ 1 | 0 |
| 2 ≤ IntraPredMode ≤ 12 | 1 |
| 13 ≤ IntraPredMode ≤ 23 | 2 |
| 24 ≤ IntraPredMode ≤ 44 | 3 |
| 45 ≤ IntraPredMode ≤ 55 | 2 |
| 56 ≤ IntraPredMode ≤ 80 | 1 |
| 81 ≤ IntraPredMode ≤ 83 | 0 |

Here, the intra prediction mode (IntraPredMode) follows the example illustrated in FIG. 3b. Also, IfnstTrSetIdx represents the index indicating a kernel set. In Table 3, intra prediction modes 81, 82, and 83 correspond to Cross-Component Linear Model (CCLM) prediction modes.

For each kernel set (lfnstTrSetIdx), two types of kernels are defined. Which kernel to select between the two types of kernels may be determined by the LFNST index. An LFNST index of 0 indicates that LFNST is not performed, while an LFNST index of 1 or 2 specifies the use of different LFNST kernels within the same kernel set. Since an additional kernel set exists according to the TU size, a total of 4×2×2=16 transform kernels are available. The kernel sizes for LFNST are defined as 16×16 and 16×48. Also, the kernel size may be adjusted according to the TU size, as shown in Table 4.

TABLE 4

| Block size | Transform size(K × L) |
|---|---|
| 4 × 4 | 8 × 16 |
| 4 × N, N × 4 (N > 8) | 16 × 16 |
| 8 × 8 | 8 × 48 |
| larger than 8 × 8 | 16 × 48 |

Meanwhile, if a DCT2/DCT2 transform kernel is applied as the primary transform to an intra predicted TU, the LFNST technique may be applied as the secondary transform.

Although the following embodiments are described with reference to the video decoding device, the embodiments may also be implemented in the video encoding device in the same way or similarly as implemented in the video decoding device.

### III. EMBODIMENTS ACCORDING TO THE PRESENT DISCLOSURE

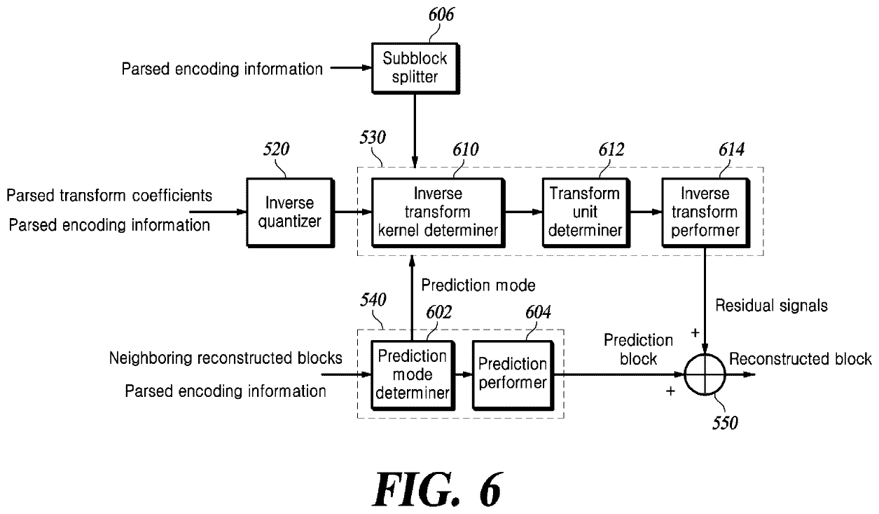

FIG. 6 is a block diagram illustrating a portion of a video decoding device in detail according to one embodiment of the present disclosure.

A video decoding device according to the present embodiment may determine prediction unit and transform unit, perform prediction and inverse transform on a current block corresponding to the determined unit using a specified prediction technique and prediction mode, and finally generate a reconstructed block of the current block. The block diagram shown in FIG. 6 may be performed by the entropy decoder 510, the inverse quantizer 520, the inverse transformer 530, the predictor 540, and the adder 550 of the video decoding device. Meanwhile, as shown in FIG. 6, the same operations may be performed by the inverse quantizer 160, the inverse transformer 165, the picture splitter 110, the predictor 120, and the adder 170 of the video encoding device. At this time, the video decoding device may use the encoding information parsed from a bitstream, but the video encoding device may use the encoding information set from a higher level module to minimize rate distortion. Hereinafter, for the convenience of description, the present embodiment is described with respect to the video decoding device.

As illustrated in FIG. 5, the predictor 540 includes an intra predictor 542 and an inter predictor 544 based on the prediction technique employed; however, as shown in FIG. 6, the predictor 540 may include a prediction mode determiner 602 and a prediction performer 604.

In the example of FIG. 6, the subblock splitter 606 may be part of the entropy decoder 510, the inverse transformer 530, or the predictor 540. From the perspective of the video encoding apparatus, the operations of the subblock splitter 606 may be performed by the inverse transformer 165, the picture splitter 110, or the predictor 120.

When the color format of the input video is YUV format (e.g., YUV420, YUV411, YUV422, YUV444), the video decoding device may first perform prediction and reconstruction of the luma component and then may perform prediction and reconstruction of the chroma components. In other words, the luma and chroma components may be sequentially reconstructed by the constituting elements illustrated in FIG. 6. Here, in the case of YUV format, the color format represents the correspondence relationship between luma component pixels and chroma component pixels.

The prediction mode determiner 602 determines the prediction technique (e.g., intra prediction, inter prediction, intra block copy (IBC) mode, or palette mode) for the current block. Also, the prediction mode determiner 602 determines a specific prediction mode for the selected prediction technique. The prediction performer 604 generates the prediction block for the current block based on the determined prediction technique and prediction mode.

The inverse quantizer 520 inversely quantizes quantized transform coefficients decoded for the current transform block to generate inverse quantization signals. At this time, the inverse quantizer 520 may perform inverse quantization using one or a plurality of inverse quantizers. When a plurality of inverse quantizers are used and the number of inverse quantizers is N_{q}, the video encoding and decoding devices may select an inverse quantizer based on a state machine with 2^{N}^{_{q}} identical states. At this time, the inverse quantizer may be selected based on the current state and the least significant bit (LSB) of the immediately preceding transform coefficient value. If k is the LSB of the previous transform coefficient value and N_{q}=2, the state transition table may be expressed as shown in Table 5.

TABLE 5

| Current state | k = 0 | k = 1 |
|---|---|---|
| 0 | 0 | 2 |
| 1 | 2 | 0 |
| 2 | 1 | 3 |
| 3 | 3 | 1 |

Also, if k is the LSB of the previous transform coefficient and N_{q}=3, the state transition table may be expressed as shown in Table 6.

TABLE 6

| Current state | k = 0 | k = 1 |
|---|---|---|
| 0 | 0 | 2 |
| 1 | 5 | 7 |
| 2 | 1 | 3 |
| 3 | 6 | 4 |
| 4 | 2 | 0 |
| 5 | 4 | 6 |
| 6 | 3 | 1 |
| 7 | 7 | 5 |

The subblock splitter 610 splits the current block into subblocks based on the subblock splitting enabling flag, splitting method flag (or index) and/or splitting direction (vertical or horizontal) flag, and the aspect ratio/width/height of the current block. Depending on the embodiment, parsing of the splitting method flag and/or the splitting direction flag (or index) may be omitted based on the aspect ratio/width/height of the current block, and the splitting method and/or splitting direction may be implicitly derived according to an agreement between the video encoding and decoding devices. At this time, flags and indices for deriving subblock splitting may be defined based on the prediction technique (inter or intra) of the current block. Also, prediction and/or transform may be performed in units of partitioned subblocks.

The inverse transformer 530 generates residual signals by inversely transforming TUs expressed by inverse quantization signals.

The adder 550 generates a reconstructed block by adding the prediction block and residual signals. The reconstructed block is stored in the memory and used later for prediction of other blocks.

Hereinafter, TU is used interchangeably with the transform block.

As shown in FIG. 6, the inverse transformer 530 may include all or some of the inverse transform kernel determiner 610, the transform unit determiner 612, and the inverse transform performer 614. The inverse transformer 530 may perform non-separable primary inverse transform (NSPIT) on the transform coefficients using the constituting elements above.

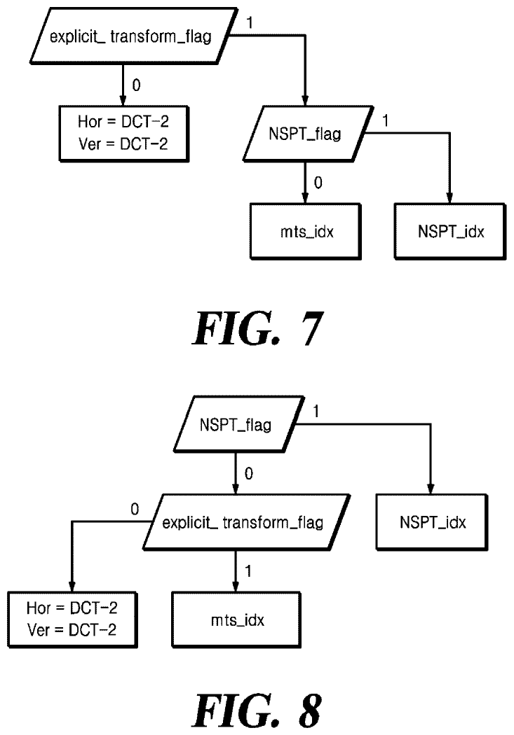

The inverse transform kernel determiner 610 determines the type of inverse transform kernel of the current transform block according to the example of FIG. 7 or FIG. 8.

FIG. 7 illustrates a method for determining an inverse transform kernel according to one embodiment of the present disclosure.

For example, the inverse transform kernel determiner 610 parses explicit_transform_flag (hereinafter, referred to as the “explicit transform flag”), which indicates whether to use an explicit inverse transform kernel. If the parsed explicit_transform_flag is 0, the horizontal and vertical inverse transform kernels are implicitly determined as DCT-2. On the other hand, if explicit_transform_flag is 1, the inverse transform kernel determiner 610 further parses NSPT_flag (hereinafter, referred to as the “non-separable primary transform flag” or “NSPT flag”), which indicates whether to apply a non-separable primary inverse transform. If NSPT_flag is 0, the horizontal and vertical inverse transform kernels may be explicitly determined according to MTS. The inverse transform kernel determiner 610 parses mts_idx to obtain the pair of horizontal and vertical transform kernels indicated by mts_idx. At this time, the vertical/horizontal kernel pairs may be defined according to an agreement between the video encoding device and the video decoding device. If NSPT_flag is 1, the inverse transform kernel determiner 610 further parses NSPT_idx (hereinafter, referred to as the “non-separable primary transform index” or “NSPT index”) to determine the type of non-separable primary inverse transform kernel. In other words, if the kernel set includes two or more inverse transform kernels, the inverse transform kernel determiner 610 may parse NSPT_idx and select the primary inverse transform kernel indicated by NSPT_idx from the kernel set. At this time, the kernel set may be selected based on factors such as the intra prediction mode of the current block and the size of the transform block. Alternatively, if the kernel set includes only one inverse transform kernel, parsing of NSPT_idx may be omitted, and the non-separable primary inverse transform kernel may be set as the one inverse transform kernel.

FIG. 8 illustrates a method for determining an inverse transform kernel according to another embodiment of the present disclosure.

In another example, the inverse transform kernel determiner 610 first parses NSPT_flag to determine whether to apply a non-separable inverse transform. If NSPT_flag is 1, the inverse transform kernel determiner 610 may further parse NSPT_idx to determine the type of non-separable primary inverse transform kernel. If NSPT_flag is 0, the inverse transform kernel determiner 610 parses explicit_transform_flag. If the parsed explicit_transform_flag is 0, the horizontal and vertical inverse transform kernels are implicitly determined as DCT-2. On the other hand, if explicit_transform_flag is 1, the horizontal and vertical inverse transform kernels may be explicitly determined. The inverse transform kernel determiner 610 may parse mts_idx to obtain the pair of horizontal and vertical transform kernels indicated by mts_idx.

For example, if the transform kernel of the current transform block is determined according to mts_idx and the current block is predicted according to a weighted sum of intra prediction mode and/or intra prediction mode and inter prediction, an MTS kernel candidate list may be determined based on the intra prediction mode of the current block and the size of the current transform block. In other words, the kernel indicated by mts_idx may be changed depending on the intra prediction mode, the size of the transform block, and the like.

For example, the MTS list for the current transform block may be determined based on the sum of absolute values of quantized transform coefficients decoded by the entropy decoder 510, the sum of absolute values of transform coefficients inversely quantized by the inverse quantizer 520, or the position (lastScanPos) of the first non-zero transform coefficient. Here, lastScanPos is determined according to scanning order, which is defined by an agreement between the video encoding and decoding devices.

For example, the number of MTS lists may be determined as follows based on the value of lastScanPos. According to an embodiment, the number of sets determined based on a threshold (the number of MTS lists) and the number of transform kernels included in each set may vary.

Transform kernel candidates for MTS: {K₀, K₁, K₂, K₃, K₄, K₅}

List candidate set 0: {K₀}, when lastScanPos≤th0

List candidate set 1: {K₀, K₁, K₂, K₃}, when th0<lastScanPos≤th1

List candidate set 2: {K₀, K₁, K₂, K₃, K₄, K₅}, when lastScanPos>th1

At this time, the threshold may be defined based on an agreement between the video encoding and decoding devices. If the size of a list candidate set determined by the threshold(s) is 1, signaling of mts_idx for kernel determination may be omitted.

In another example, the inverse transform kernel determiner 610 may parse MTS_ver_idx and MTS_hor_idx to determine the kernels for vertical and horizontal directions, respectively. MTS_ver_idx and MTS_hor_idx indicate the kernels for vertical and horizontal directions, respectively.

Meanwhile, when a non-separable primary inverse transform is applied, a kernel set for the non-separable primary inverse transform may be determined based on the intra prediction mode of the current block and/or the size of the current transform block. Hereinafter, it is assumed that M kernel sets exist based on T (Tbw×TbH) transform blocks that satisfy “minNSPT≤Tbw, TbH≤maxNSPT” and intra prediction mode and C inverse transform kernel candidates exist for each kernel set. At this time, minNSPT and minNSPT may be defined based on an agreement between the video encoding device and the video decoding device.

For example, the intra prediction mode illustrated in FIG. 3b may be divided into six mode sets as shown in Table 7.

TABLE 7

| IntraPredMode | Mode Set |
|---|---|
| IntraPredMode < 0 | 1 |
| 0 ≤ IntraPredMode ≤ 1 | 0 |
| 2 ≤ IntraPredMode ≤ 12 | 1 |
| 13 ≤ IntraPredMode ≤ 23 | 2 |
| 24 ≤ IntraPredMode ≤ 44 | 3 |
| 45 ≤ IntraPredMode ≤ 55 | 4 |
| 56 ≤ IntraPredMode ≤ 80 | 5 |

Based on Table 7, the number of kernel sets M may be defined as 6×T. In other words, the kernel sets may be divided into M sets based on the size of the transform block and the intra prediction mode (whether the mode is a directional or non-directional mode and the prediction direction in the case of directional mode).

For example, by utilizing the symmetry of square blocks, the mode sets in Table 7 for square blocks may be divided into mode sets as shown in Table 8.

TABLE 8

| IntraPredMode | Mode Set |
|---|---|
| IntraPredMode < 0 | 1 |
| 0 ≤ IntraPredMode ≤ 1 | 0 |
| 2 ≤ IntraPredMode ≤ 12 | 1 |
| 13 ≤ IntraPredMode ≤ 23 | 2 |
| 24 ≤ IntraPredMode ≤ 44 | 3 |
| 45 ≤ IntraPredMode ≤ 55 | 2 |
| 56 ≤ IntraPredMode ≤ 80 | 1 |

If mode sets as shown in Table 8 are employed, mode m and mode 68-m are included in the same mode set. Therefore, in the case of mode m and mode 68-m, the inverse transform kernel determiner 610 may use the same kernel set for the non-separable primary transform.

In Tables 7 and 8, modes −1 to −14 and modes 67 to 80 correspond to wide angle prediction modes. Wide angle prediction modes may be classified into a separate prediction mode group or included in the same prediction mode group as the closest directional mode.

Also, matrix-based intra prediction modes may be included in the non-directional mode group (mode group 0) or classified into a separate group.

In another example, in the case of rectangular blocks, M kernel sets may be identified based on the mode group defined in Table 7. In this case, for non-separable transforms, a transform block having a size of A×B and predicted in m mode may use the same kernel as a block having a size of B×A and predicted in 68-m mode.

For example, the number of inverse transform kernel candidates C of each kernel set for the current transform block may be adaptively determined based on the sum of absolute values of quantized transform coefficients decoded by the entropy decoder 510, the sum of absolute values of transform coefficients inversely quantized by the inverse quantizer 520, or the position (lastScanPos) of the first non-zero transform coefficient. Based on one or more thresholds, the video decoding device may compare the sum of absolute values or lastScanPos with the threshold(s) to determine the number of inverse transform kernel candidates.

For example, the number of inverse transform kernel candidates may be determined by comparing lastScanPos with a threshold th. If lastScanPos is less than or equal to the threshold, the inverse transform kernel determiner 610 may set the number of inverse transform kernel candidates to N₀ (a non-negative integer). On the other hand, if lastScanPos exceeds the threshold, the number of inverse transform kernel candidates may be set to N₁ (an integer greater than or equal to 1).

Subsequently, inverse transform kernel determiner 610 may parse NSPT_idx to determine the candidate indicated by the parsed NSPT_idx among the inverse transform kernel candidates as the non-separable primary inverse transform kernel. If there is only one inverse transform kernel candidate, the candidate may be selected as the non-separable primary inverse transform kernel without additional parsing of NSPT_idx.

If the width and/or height of the current transform block is larger than maxNSPT, which is the maximum size of a transform block for which the non-separable primary inverse transform may be applied, the transform unit determiner 612 may implicitly divide the current transform block until its width and height become smaller than maxNSPT.

For example, if either the width or the height of the current transform block (or transform subblock) exceeds maxNSPT, the transform unit determiner 612 may divide the current transform block (or transform sub-block) as follows.

If the width T_{W} of the current transform block (or the width sbT_{W} of the transform subblock) is larger than maxNSPT, the transform unit determiner 612 may recursively perform SPLIT_BT_VER (vertical binary tree split) until the width of partitioned transform blocks becomes less than or equal to maxNSPT. Alternatively, if the height T_{H} of the current transform block (or the height sbT_{H} of the transform subblock) is larger than maxNSPT, the transform unit determiner 612 may recursively perform SPLIT_BT_HOR (horizontal binary tree split) until the height of partitioned transform blocks becomes less than or equal to maxNSPT.

In another example, if both the width and the height of the current transform block (or transform subblock) are larger than maxNSPT, the transform unit determiner 612 may use SPLIT_QT (quadtree split) to partition the current transform block into four subblocks.

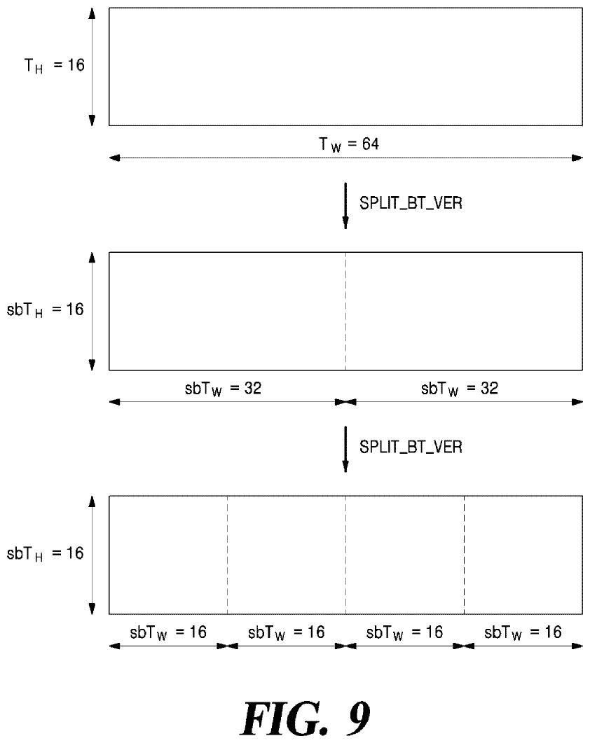

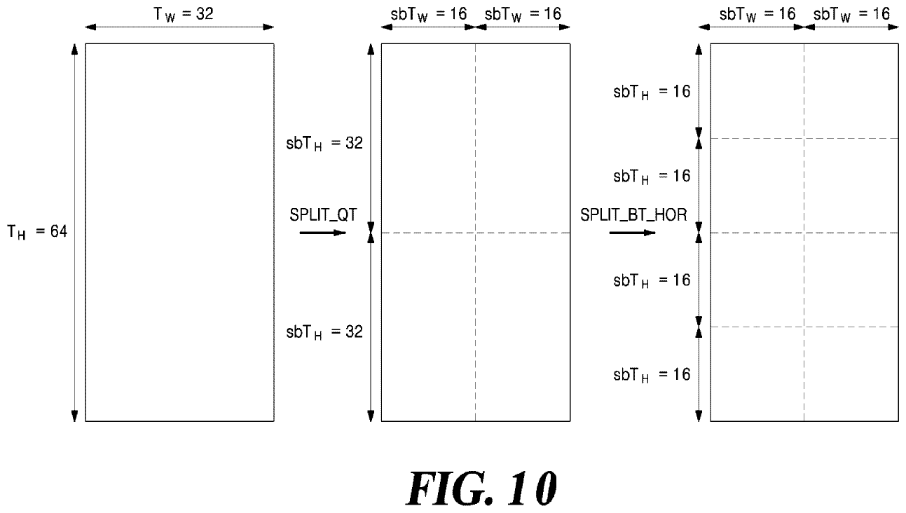

For example, when maxNSPT is 16, the transform unit determiner 612 may implicitly partition a transform block with T_{W}=64 and T_{H}=16 as illustrated in FIG. 9. Also, when maxNSPT is 16, the transform unit determiner 612 may implicitly partition a transform block with T_{W}=32 and T_{H}=64 as illustrated in FIG. 10.

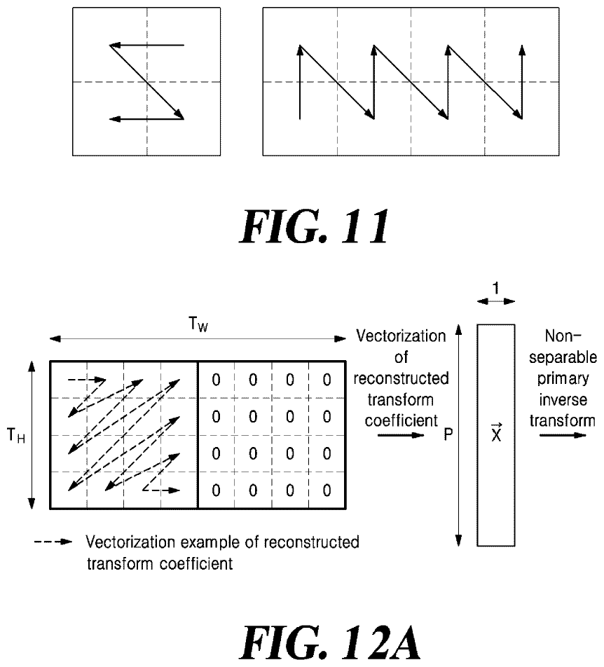

Meanwhile, the partitioned subblocks may be inversely transformed and reconstructed sequentially by following a z-scan order. At this time, the order of inverse transform for the subblocks may be determined based on the intra prediction mode of the current block. If the intra prediction mode of the current block is a vertical mode (mode 50) or greater than a specific mode k (where k>50), subblocks may be inversely transformed using a z-scan order starting from the top-right subblock, as illustrated in the left example of FIG. 11. Also, if the intra prediction mode is a horizontal mode (mode 18) or less than a specific mode k (where k<18), subblocks may be inversely transformed using a z-scan order starting from the bottom-left subblock, as illustrated in the right example of FIG. 11.

For example, if the width and/or height of the current transform block is larger than a specific size maxNTsize, which is predetermined according to an agreement between the video encoding device and the video decoding device, parsing of NSPT_flag and NSPT_idx may be omitted, and non-separable transform/inverse transform may not be performed. Also, if the width and/or height of the current transform block is smaller than minNSPT, parsing of NSPT_flag and NSPT_idx may be omitted, and non-separable transform/inverse transform may not be performed. Here, maxNTsize represents the maximum size of a transform block for which NSPT_flag is parsed, and maxNSPT represents the maximum size of a transform block size to which a non-separable transform/inverse transform may actually be applied. Also, minNSPT represents the minimum size of a transform block size to which a non-separable transform/inverse transform may actually be applied.

Hereinafter, maxNTsize is referred to as the “predefined maximum NSPT size.” Also, maxNSPT represents the “predefined maximum size for NSPT application,” and minNSPT represents the “predefined minimum size for NSPT application.”

The inverse transform performer 614 performs inverse transform based on the inverse transform kernel and the size of the transform block. The inverse transform performer 614 may parse a secondary transform flag or a secondary transform index to determine whether to perform a secondary inverse transform (i.e., LFNST). If the secondary transform index is parsed and the parsed secondary transform index is 0, the inverse transform performer 614 does not perform the secondary inverse transform. When the secondary inverse transform is performed, the inverse transform performer 614 reconstructs primary transform coefficients by performing the secondary inverse transform on the inversely quantized secondary transform coefficients and subsequently performs the primary inverse transform on the primary transform coefficients to reconstruct residual signals. If the secondary inverse transform is not performed, the inverse transform performer 614 reconstructs residual signals by performing the primary inverse transform on the inversely quantized primary transform coefficients.

Depending on embodiments, the secondary inverse transform and the non-separable primary inverse transform may not be performed simultaneously. In other words, if the secondary inverse transform is determined to be performed based on the parsing of the secondary transform flag or the secondary transform index, parsing of NSPT_flag and NSPT_idx may be omitted. Alternatively, if NSPT_flag is 1, the secondary transform flag or secondary transform index may implicitly be derived as 0.

If the non-separable primary inverse transform is performed on the current transform block with a width T_{W} and a height T_{H}, the inverse transform performer 614 may multiply the reconstructed transform coefficients of size P by the inverse transform matrix (i.e., inverse transform kernel) invT, which has dimensions P×(T_{W}×T_{H}), to perform inverse transform as expressed by Equation 2.

$$\vec{Y} = invT \cdot \vec{X} \qquad [ Equation 2 ]$$

Here, \vec{Y} represents the vector of residual signals reconstructed through inverse transform. \vec{X} denotes the primary transform coefficient vector, reconfigured from the reconstructed transform coefficients of size P according to scanning order. Here, the scanning order may be predefined according to an agreement between the video encoding device and the video decoding device. Also, the scanning order may vary depending on the embodiment, including the z-scan order.

Meanwhile, a relationship may hold such that P≤T_{W}×T_{H}. For example, the size P may be determined as a multiple of the Coefficient Group (CG). The size of CG, W_{CG}×_{HCG}, may vary, which may be 4×4, 8×8, and so on depending on embodiments. Also, the size of P may be determined based on the size of the current transform block.

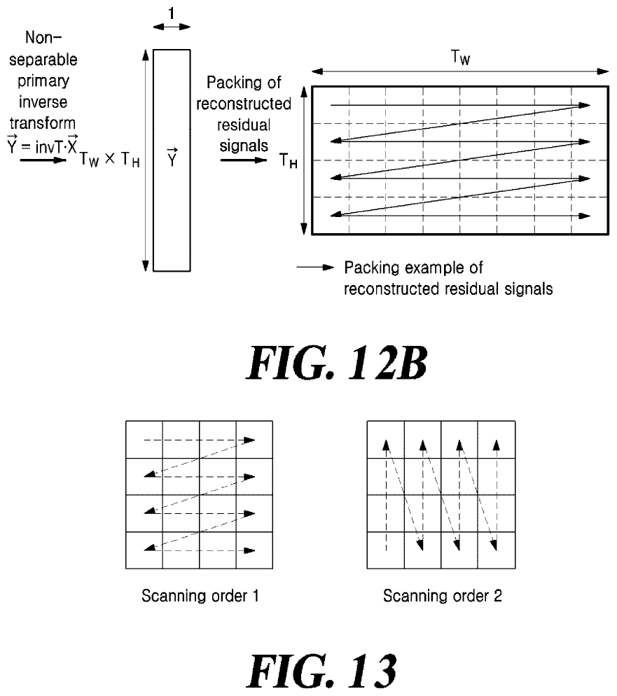

For instance, if a relationship holds such that P≤T_{W}×T_{H}, an inverse transform process for the reconstructed transform coefficients may be described as illustrated in FIGS. 12A and 12B. In this case, the size of P, the vectorization scanning order of the reconstructed transform coefficients, and the packing method for the reconstructed residual signals (i.e., the scanning order) may vary depending on embodiments.

When a non-separable primary inverse transform is applied to a square transform block, the inverse transform performer 614 may perform the inverse transform using the same inverse transform kernel for both the block predicted by the intra prediction mode m and the block predicted by mode 68-m. At this time, when reconstructed transform coefficients are reconfigured into a primary transform coefficient vector \vec{X}, the scanning order may be adaptively changed according to the intra prediction mode.

For example, for an intra prediction mode L (where 2≤L≤34) closer to the horizontal direction mode (mode 18) rather than the vertical direction mode, the inverse transform performer 614 may use scanning order 1 (or scanning order 2), as illustrated in FIG. 13, to generate the vector \vec{X}. Also, for an intra prediction mode L (where 34<L≤66) closer to the vertical direction mode (mode 50), the inverse transform performer 614 may use scanning order 2 (or scanning order 1) to generate the vector \vec{X}.

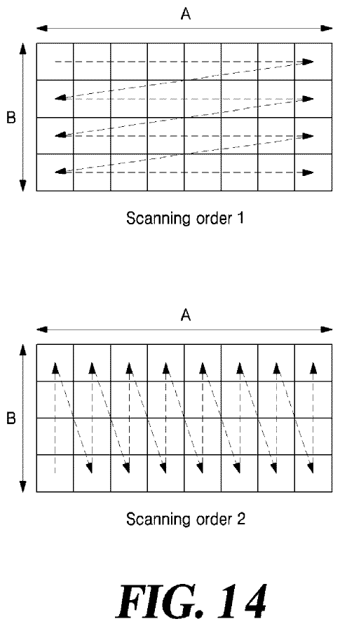

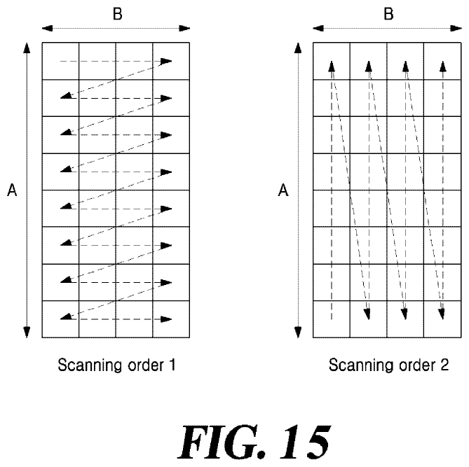

When a non-separable primary inverse transform is applied to a rectangular transform block, the inverse transform performer 614 may perform the non-separable primary transform using the same kernel on the block having a size of A×B and predicted in mode m (2≤m≤34) and the block having a size of B×A and predicted in mode 68-m. At this time, in the case of the A×B block predicted in the mode m (2≤m≤34), the inverse transform performer 614 may generate the vector \vec{X} using the scanning order 1 (or scanning order 2) illustrated in FIG. 14. Also, in the case of the B×A block and predicted in the mode 68-m, the inverse transform performer 614 may generate the vector \vec{X} using the scanning order 2 (or scanning order 1) illustrated in FIG. 15.

When the transform block is implicitly split into subblocks by the transform unit determiner 612, the prediction performer 604 may perform intra prediction of the current subblock using reconstructed reference samples of a subblock reconstructed first according to the z-scanning order.

Hereinafter, methods for transforming and inversely transforming a transform block of the current block are described.

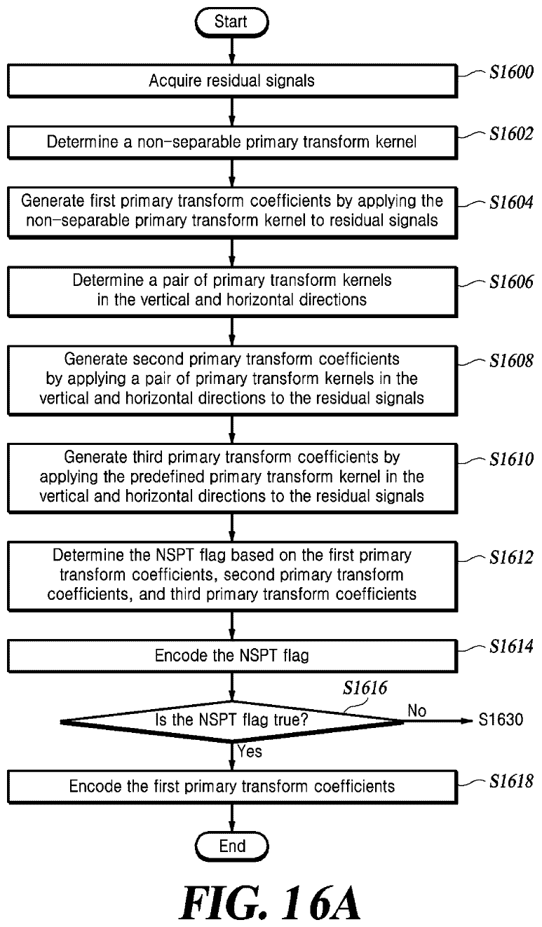

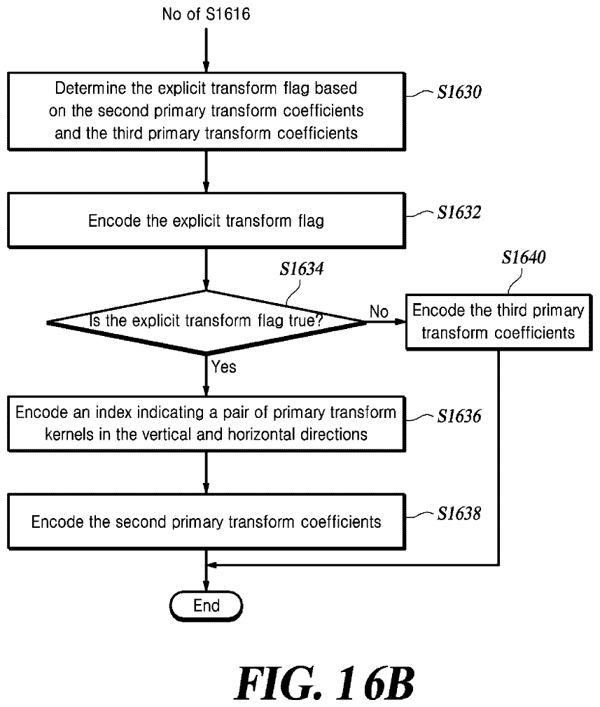

FIGS. 16A and 16B are flow diagrams illustrating a method for transforming a transform block by a video encoding device according to one embodiment of the present disclosure.

The video encoding device acquires residual signals for a transform block of the current block (S1600).

The video encoding device determines a non-separable primary transform kernel based on the size of a transform block, intra prediction mode of the current block, and characteristics of quantized transform coefficients (S1602).

The video encoding device selects a mode set that includes the intra prediction mode of the current block among predefined mode sets. The video encoding device selects a kernel set based on the size of the transform block and the selected mode set.

If the kernel set includes a single transform kernel candidate, the video encoding device determines the single kernel candidate as the non-separable primary transform kernel.

If the kernel set includes a plurality of transform kernel candidates, the video encoding device may determine one of the plurality of transform kernel candidates as the non-separable primary transform kernel in terms of bitrate-distortion optimization. Subsequently, the video encoding device may encode an index indicating the determined candidate.

The video encoding device applies the non-separable primary transform kernel to the residual signals to generate the first primary transform coefficients (S1604).

The video encoding device generates a one-dimensional vector of residual signals by arranging all or part of the residual signals in a predefined first scanning order based on the size and type of the non-separable primary transform kernel. The video encoding device performs matrix multiplication between the vector of residual signals and the non-separable primary transform kernel to generate a primary transform coefficient vector. The video encoding device allocates the primary transform coefficient vector to the transform block according to the predefined scanning order to generate the primary transform coefficients.

The video encoding device may adaptively determine the number of inverse transform kernel candidates for the kernel set based on the sum of absolute values of transform coefficients or the position of the first non-zero transform coefficient.

The video encoding device determines a pair of primary transform kernels in the vertical and horizontal directions for the transform block (S1606).

The video encoding device applies a pair of primary transform kernels in the vertical and horizontal directions to the residual signals to generate second primary transform coefficients (S1608).

The video encoding device applies predefined primary transform kernels in the vertical and horizontal directions to the residual signals to generate third primary transform coefficients (S1610).

The video encoding device determines the NSPT flag based on the first, second, and third primary transform coefficients (S1612). Here, the NSPT flag indicates whether to apply the non-separable primary transform.

From the perspective of rate-distortion optimization, the video encoding device may determine the NSPT flag. For example, if the first primary transform coefficients are optimal, the video encoding device may set the NSPT flag to true. On the other hand, if the second or third primary transform coefficients are optimal, the video encoding device may set the NSPT flag to false.

The video encoding device encodes the NSPT flag (S1614).

The video encoding device checks the NSPT flag (S1616).

If the NSPT flag is true (Yes in S1616), the video encoding device encodes the first primary transform coefficients (S1618). The video encoding device may quantize and entropy-encode the first primary transform coefficients to generate a bitstream of the first primary transform coefficients.

On the other hand, if the NSPT flag is false (No in S1616), the video encoding device performs the following steps.

The video encoding device determines an explicit transform flag based on the second and third primary transform coefficients (S1630). Here, the explicit transform flag indicates whether to use a pair of primary transform kernels in the vertical and horizontal directions.

From the perspective of rate-distortion optimization, the video encoding device may determine the explicit transform flag. For example, if the second primary transform coefficients are optimal, the video encoding device may set the explicit transform flag to true. On the other hand, if the third primary transform coefficients are optimal, the video encoding device may set the explicit transform flag to false.

The video encoding device encodes the explicit transform flag (S1632).

The video encoding device checks the explicit transform flag (S1634).

If the explicit transform flag is true (Yes in S1634), the video encoding device performs the following steps.

The video encoding device encodes an index indicating a pair of primary transform kernels in the vertical and horizontal directions (S1636).

The video encoding device encodes the second primary transform coefficients (S1638). The video encoding device may quantize and entropy-encode the second primary transform coefficients to generate a bitstream of the second primary transform coefficients.

On the other hand, if the explicit transform flag is false (No in S1634), the video encoding device encodes the third primary transform coefficients (S1640). The video encoding device may quantize and entropy-encode the third primary transform coefficients to generate a bitstream of the third primary transform coefficients.

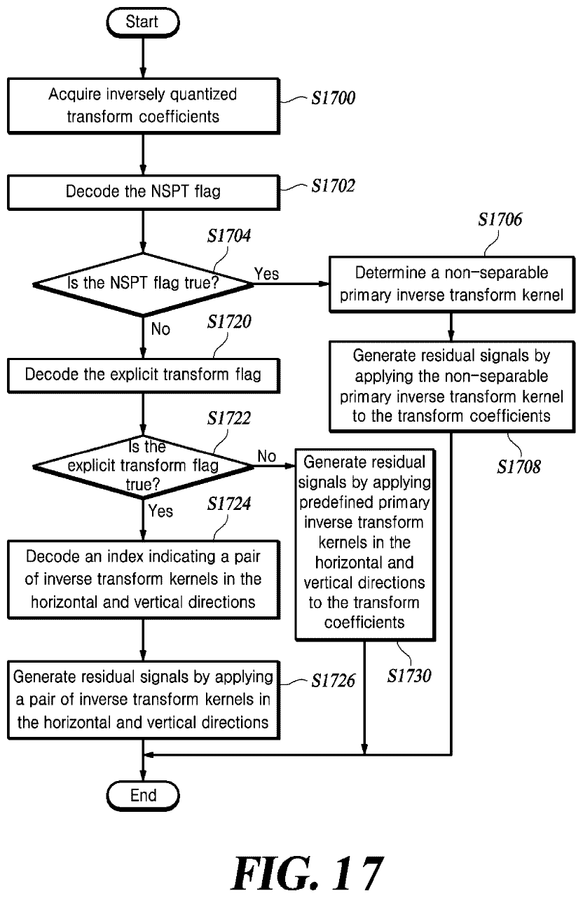

FIG. 17 is a flow diagram illustrating a method for inversely transforming a transform block by a video decoding device according to one embodiment of the present disclosure.

The video decoding device acquires inversely quantized transform coefficients for a transform block of the current block (S1700).

The video decoding device decodes the NSPT flag from a bitstream (S1702). Here, the NSPT flag indicates whether to apply a non-separable primary transform.

The video decoding device checks the NSPT flag (S1704).

If the NSPT flag is true (Yes in S1704), the video decoding device performs the following steps.

The video decoding device determines the non-separable primary inverse transform kernel based on the size of the transform block, intra prediction mode of the current block, and characteristics of quantized transform coefficients (S1706).

The video decoding device selects a mode set that includes the intra prediction mode of the current block among predefined mode sets. The video decoding device selects a kernel set based on the size of the transform block and the selected mode set.

The video decoding device adaptively determines the number of inverse transform kernel candidates for the kernel set based on the sum of absolute values of inversely quantized transform coefficients or the position of the first non-zero transform coefficient.

If the kernel set includes a single inverse transform kernel candidate, the video decoding device determines the single kernel candidate as the non-separable primary inverse transform kernel.

Alternatively, if the kernel set includes a plurality of inverse transform kernel candidates, the video decoding device decodes the NSPT index from a bitstream. The video decoding device may determine a candidate indicated by the NSPT index among a plurality of inverse transform kernel candidates as the non-separable primary inverse transform kernel.

The video decoding device generates residual signals by applying the non-separable primary inverse transform kernel to the transform coefficients to performs the primary inverse transform (S1708).

The video decoding device, based on the size and type of the non-separable primary inverse transform kernel, packs all or part of the transform coefficients into a one-dimensional vector according to a predefined scanning order to generate a vector of primary transform coefficients. The video decoding device performs matrix multiplication between the primary transform coefficient vector and the non-separable primary inverse transform kernel to generate a vector of residual signals. The video decoding device allocates the vector of residual signals to the transform block according to the predefined scanning order to generate residual signals.

Meanwhile, if the NSPT flag is false (No in S1704), the video decoding device performs the following steps.

The video decoding device decodes the explicit transform flag from a bitstream (S1720). Here, the explicit transform flag indicates whether to explicitly use a pair of inverse transform kernels in the horizontal and vertical directions.

The video decoding device checks the explicit transform flag (S1722).

If the explicit transform flag is true (Yes in S1722), the video decoding device performs the following steps.

The video decoding device decodes an index indicating a pair of inverse transform kernels in the horizontal and vertical directions from the bitstream (S1724). Here, the index indicates one of a plurality of pairs of inverse transform kernels in the horizontal and vertical directions.

The video decoding device applies a pair of inverse transform kernels in the horizontal and vertical directions indicated by the index to the transform coefficients to generate residual signals (S1726).

On the other hand, if the explicit transform flag is false (No in S1722 step), the video decoding device applies predefined primary inverse transform kernels in the horizontal and vertical directions to the transform coefficients to generate residual signals (S1730).

Subsequently, the video decoding device may add the residual signals and the prediction block of the current block to generate a reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

140: Transformer
165: Inverse transformer
530: Inverse transformer
606: Subblock splitter
610: Inverse transform kernel determiner
612: Transform unit determiner
614: Inverse transform performer

### CROSS-REFERENCE TO RELATED APPLICATIONS

This application claims priority to and the benefit of Korean Patent Application No. 10-2022-0124290 filed on Sep. 29, 2022, and Korean Patent Application No. 10-2023-0105462, filed on Aug. 11, 2023, the entire contents of each of which are incorporated herein by reference.

What is claimed is:

1. A method for reconstructing a current block, performed by a video decoding device, the method comprising:
acquiring inversely-quantized transform coefficients for a transform block of the current block;
decoding a Non-separable Primary Transform (NSPT) flag from a bitstream, wherein the NSPT flag indicates whether to apply non-separable primary transform;
checking the NSPT flag;
when the NSPT flag is true, determining a non-separable primary inverse transform kernel based on a size of the transform block, an intra prediction mode of the current block, and characteristics of the inversely-quantized transform coefficients; and
performing a primary inverse transform by generating residual signals by applying the non-separable primary inverse transform kernel to the inversely-quantized transform coefficients.

2. The method of claim 1, further comprising:
when the NSPT flag is false, obtaining explicitly or implicitly a pair of primary inverse transform kernels in vertical and horizontal directions for the transform block; and
generating the residual signals by applying the pair of primary inverse transform kernels in the vertical and horizontal directions to the inversely-quantized transform coefficients.

3. The method of claim 1, wherein determining the non-separable primary inverse transform kernel includes:
selecting a mode set that includes an intra prediction mode of the current block among predefined mode sets; and
selecting a kernel set based on the size of the transform block and the selected mode set.

4. The method of claim 3, wherein determining the non-separable primary inverse transform kernel comprises:
adaptively determining a number of inverse transform kernel candidates for the kernel set based on a sum of absolute values of the inversely-quantized transform coefficients, or a position of first non-zero transform coefficient.

5. The method of claim 3, further comprising, when the kernel set includes a plurality of inverse transform kernel candidates, decoding an NSPT index,
wherein determining the non-separable primary inverse transform kernel comprises:
determining a candidate indicated by the NSPT index among the plurality of inverse transform kernel candidates as the non-separable primary inverse transform kernel.

6. The method of claim 1, wherein the non-separable primary inverse transform kernel is a matrix with a size of ‘P×the size of the transform block’, the size of the transform block is defined as a product of a width and a height of the transform block, and the size of P corresponds to the size of a one-dimensional vector constructed by packing the inversely-quantized transform coefficients.

7. The method of 6, wherein the size of P is less than or equal to the size of the transform block and is determined based on the size of the transform block.

8. The method of claim 1, wherein, when a width and a height of the transform block are larger than or equal to a predefined minimum size applicable for NSPT and less than or equal to a predefined maximum size for NSPT, decoding the NSPT flag is performed,
wherein the predefined minimum size applicable for NSPT represents a minimum size of a transform block for which the non-separable primary transform is applied, and the predefined maximum size for NSPT represents a maximum size of a transform block for decoding the NSPT flag.

9. The method of claim 8, wherein, when the width and the height of the transform block are larger than or equal to the predefined minimum size applicable for NSPT and less than or equal to a predefined maximum size applicable for NSPT, determining the non-separable primary inverse transform kernel is performed,
wherein the predefined maximum size applicable for NSPT is less than or equal to the predefined maximum size for NSPT and represents a maximum size of a transform block for which the non-separable primary transform is applied.

10. The method of claim 9, wherein, when the width and height of the transform block are larger than the predefined maximum size applicable for NSPT, determining the non-separable primary inverse transform kernel comprises:
splitting the transform block implicitly and recursively to generate subblocks until the width and height of the subblocks become smaller than the predefined maximum size applicable for NSPT.

11. The method of claim 10, wherein the subblocks are inversely transformed sequentially according to z-scan order, and the z-scan order is determined based on the intra prediction mode of the current block.

12. The method of claim 1, wherein performing the primary inverse transform comprises:
based on size and type of the non-separable primary inverse transform kernel, packing all or part of the inversely-quantized transform coefficients into a one-dimensional vector according to a predefined first scanning order to generate a primary transform coefficient vector;
performing matrix multiplication between the primary transform coefficient vector and the non-separable primary inverse transform kernel to generate a vector of the residual signals; and
allocating the vector of the residual signals to the transform block according to a predefined second scanning order to generate the residual signals.

13. The method of claim 1, wherein, when the NSPT flag is true, a secondary transform flag or a secondary transform index is implicitly set to 0, wherein the secondary transform flag or the secondary transform index indicates whether to perform secondary transform.

14. A method for encoding a current block, performed by a video encoding device, the method comprising:
acquiring residual signals for a transform block of the current block;
determining a non-separable primary transform kernel based on a size of the transform block, an intra prediction mode of the current block, and characteristics of quantized transform coefficients;
generating first primary transform coefficients by applying the non-separable primary transform kernel to the residual signals;
determining explicitly or implicitly a primary transform kernel pair in vertical and horizontal directions for the transform block; and
generating second primary transform coefficients by applying the first primary transform kernel pair to the residual signals.

15. The method of claim 14, further comprising:
determining a non-separable primary transform flag based on the first primary transform coefficients and the second primary transform coefficients, wherein the NSPT flag indicates whether to apply non-separable primary transform; and
encoding the NSPT flag.

16. The method of claim 15, further comprising:
encoding the first primary transform coefficients or the second primary transform coefficients based on the NSPT flag.

17. A computer-readable recording medium storing a bitstream generated by a video encoding method, the video encoding method comprising:
acquiring residual signals for a transform block of a current block;
determining a non-separable primary transform kernel based on a size of the transform block, an intra prediction mode of the current block, and characteristics of quantized transform coefficients;
generating first primary transform coefficients by applying the non-separable primary transform kernel to the residual signals;
determining explicitly or implicitly a primary transform kernel pair in vertical and horizontal directions for the transform block; and
generating second primary transform coefficients by applying the primary transform kernel pair to the residual signals.
